(19) United States
(12) Patent Application Publication
(10) Pub. No.: US 2007/0272338 A1
(43) Pub. Date: Nov. 29, 2007

(54) Tire and Crosslinkable Elastomeric Composition

(76) Inventors: Maurizio Galimberti, Milano (IT); Luca Giannini, Milano (IT); Liugi Fino, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/576,797

(22) PCT Filed: Oct. 29, 2004
(86) PCT No.: PCT/IT04/00598

§ 371 Date: Apr. 27, 2007

(30) Foreign Application Priority Data
Oct. 31, 2003 (EP) PCT EP03 12137

(51) Int. Cl. B60C 1/00

(52) U.S. Cl. 152/458; 521/148

(57) ABSTRACT

Tire having at least one structural element including a crosslinked elastomeric material obtained by crosslinking a crosslinkable elastomeric composition containing (a) 100 phr of at least one diene elastomeric polymer; (b) 1 phr to 50 phr, preferably 2 phr to 40 phr, and more preferably 5 phr to 30 phr, of at least one layered material having an individual layer thickness of 0.01 nm to 30 nm, preferably 0.05 nm to 15 nm; (c) 0.1 phr to 15 phr, preferably 0.3 phr to 10 phr, of at least one methylene donor compound; and (d) 0.4 phr to 20 phr, preferably 0.8 phr to 15 phr of at least one methylene acceptor compound. Preferably, the at least one structural element is selected from bead filler, sidewall insert tread underlayer, or tread base.

The present invention relates to a tire and to a crosslinkable elastomeric composition.

More in particular the present invention relates to a tire including at least one structural element obtained by crosslinking a crosslinkable elastomeric composition comprising at least one diene elastomeric polymer, at least one layered material, at least one methylene donor compound and at least one methylene acceptor compound.

Moreover, the present invention also relates to a crosslinkable elastomeric composition comprising at least one diene elastomeric polymer, at least one layered material, at least one methylene donor compound and at least one methylene acceptor compound, as well as to a crosslinked manufactured article obtained by crosslinking said crosslinkable elastomeric composition.

In the rubber industry, in particular that of tires for vehicle wheels, it is known practice to add organic fibres such as, for example, polyamide fibres (in particular, aromatic polyamide fibres known as “aramide fibres”), polyester fibres or polyolefin fibres, to elastomeric compositions, in order to improve their mechanical properties (both static and dynamic).

For example, U.S. Pat. No. 4,871,004 discloses a composition comprising a crosslinkable elastomer and an effective amount of aramid fibres. Examples of crosslinkable elastomers which are useful for this purpose are: natural rubber, cis-1,4-polyisoprene, polybutadiene (in solution or in emulsion), styrene/butadiene copolymers (in solution or in emulsion), butyl rubbers and halobutyl rubbers, EPDM, butadiene/acrylonitrile rubbers, neoprene, vinylpolybutadiene and, in general, polymers with viscoelastic properties, or blends thereof. Said composition is said to be usable in all cases in which rubbers with a high level of hardness and/or a high modulus are required, in particular in vehicle tires (for example as bead filler). One of the reasons which justifies the use of the abovementioned fibres is the improvement in the structural strength of the crosslinked manufactured article.

European Patent Application EP 691,218 discloses a tire component for a pneumatic tire comprising a reinforced crosslinkable composition, said composition including a crosslinkable elastomeric matrix material having dispersed therein an effective reinforcing amount of partially oriented fibres having a modulus of less than 10 GPa, preferably less than 6 GPa. As an alternative embodiment, a tire component may be reinforced with a mixture of a partially oriented fibres and fibrillated pulp fibres (i.e. Kevlar® pulp). The partially oriented fibres may comprise as specific examples, polyamides, polyesters, polyolefins, and a polymer selected from the group consisting of nylon 6, nylon 46, nylon 66, polyethylene, polypropylene, polyethylene-terephthalate (PET). The above mentioned reinforced crosslinkable composition is said to have an improved stiffness without negatively affecting its remaining properties such as, for example, hysteresis and fatigue endurance.

International Patent Application WO 02/24596 in the name of the Applicant discloses a tire with an elastomeric intermediate layer disposed between the tread band and the belted plies wherein the elastomeric intermediate layer is made of a fibre-reinforced material. Said elastomeric intermediate layer may be reinforced with short reinforcing fibres such as, for example, aramide fibres (i.e. Kevlar® pulp) to improve its modulus of elasticity, among other mechanical properties.

The mechanical properties of the elastomeric compositions may be also improved by increasing crosslinking density of the elastomeric composition by using a large amount of sulfur; or by using a large amount of carbon black, or a very fine and structured carbon black which has a high reinforcing capacity.

However, the above ways of improving mechanical properties may lead to a number of drawbacks.

For example, the addition of organic fibres due to their poor dispersion, may impair the processability of the non-crosslinked elastomeric compositions and therefore the quality of the finished product, both in term of mechanical properties and of surface appearance. This may cause a reduction in their tear resistance and detachments from the other elastomeric compositions present in the tire both during manufacturing process or during use of the same. Moreover, the organic fibres have a remarkable anisotropic behaviour, namely they substantially orient in the direction of the shear forces exerted during extrusion and calendering of the non-crosslinked elastomeric composition to form a layer of elastomeric material (usually named “calendering direction”), so as to give to the tyre essentially a longitudinal reinforcement, namely a reinforcement essentially in the circumferential direction of the tire.

On the other hand, the use of a large amount of sulfur may cause remarkable reversion phenomena, which result in modifications of the tire performances during use. On the other side, it is known that carbon black gives pronounced hysteresis properties to the elastomeric composition, namely an increase in the dissipated heat under dynamic conditions, which results in an increase in the rolling resistance of the tire. In addition, a large amount of carbon black remarkably increases viscosity of the non-crosslinked elastomeric composition and, consequently, has a negative impact on its processability and extrudability.

To overcome the drawbacks caused by the use of carbon black, the so called “white” reinforcing fillers are usually used, in paricular silica, in total or partial replacement for the carbon black. However, although the use of said reinforcing fillers leads to good tear resistance, it also entails a series of drawbacks essentially related to the poor affinity of these fillers with respect to the elastomeric polymers commonly used in the manufacturing of tires. In particular, to obtain a good degree of dispersion of the silica in the elastomeric matrix, it is necessary to subject the elastomeric composition to a prolonged thermomechanical blending action. To increase the affinity of the silica with the elastomeric matrix, it is necessary to use suitable coupling agents such as, for example, sulfur-containing organosilane products. However, the need to use such coupling agents places a limitation on the maximum temperature which may be reached during the blending and thermomechanical processing operations of the elastomeric composition, to avoid the penalty of an irreversible degradation of the coupling agent which might cause a premature crosslinking of the elastomeric compositions (scorching phenomena).

Therefore, other ways have been found to improve mechanical properties of the elastomeric compositions.

For example, U.S. Pat. No. 5,840,795 relates to a treated clay product comprising a hydrous kaolin clay surface treated with a multi-component system consisting of a functional silane, a methylene donor compound such as hexamethylenetetramine, and a multifunctional methylene acceptor such as resorcinol. The abovementioned surface treated clay may be used as a reinforcing filler in elastomeric compositions which are said to give crosslinked manufactured articles having improved physical properties such as modulus, tensile, tear, wear resistance and/or resistance to heat build-up.

European Patent Application EP 1,193,085 relates to a tire with a rubber/cord laminate, sidewall insert and apex including a rubber composition comprising, based upon parts by weight of an ingredient per 100 parts by weight elastomer (phr):
(A) 100 phr of at least one diene-base elastomer;
(B) 30 phr to 100 phr of particulate reinforcement dispersed within said elastomer(s) selected from intercalated smectite, preferably montmorillonite, clay particles, carbon black, synthetic amorphous silica and silica treated carbon black, comprised of:
   (1) 1 phr to 10 phr of said intercalated, layered, thin, substantially two dimensional smectite, preferably montmorillonite, clay particles of which at least a portion thereof is in a form of thin, flat, substantially two dimensional exfoliated platelets derived from said intercalated clay; and
   (2) 20 phr to 99 phr of at least one additional reinforcing filler comprised of carbon black, synthetic amorphous silica and silica treated carbon black.

The abovementioned rubber composition is said to have improved stiffness and tensile modulus with only a small increase of Tan delta values.

U.S. Patent Application 2003/0004250 relates to a light weight rubber composition comprising (1) an amino group containing rubbery polymer, wherein said amino group containing rubbery polymer contains from about 0.1 weight percent to about 20 weight percent of a monomer containing an amino group, and (2) from about 0.1 phr to about 25 phr of a 2:1 layered silicate clay. The abovementioned rubber composition, having improved tensile strength and elongation at break, is said to be useful in the manufacturing of rubber articles such as power transmission belts and tires, in particular tire tread band and sidewalls.

However, also the use of said layered material may cause some drawbacks.

The Applicant has noticed that, in particular in the case of elastomeric compositions which usually require a high reinforcement such as those used, for example, for making bead fillers, sidewall inserts, tread underlayers, tread base, the use of a layered material as reinforcing filler may not be sufficient to achieve the desired properties.

In order to achieve more reinforcement, a large amount of layered material may be used. However, some drawbacks may be encountered in the elastomeric compositions so obtained such as, for example, a decrease in their tear resistance and detachments from the other elastomeric compositions present in the tire, in particular during the use of the same. Moreover, in particular in the case of layered material previously treated with a compatibilizing agent (for example, a quaternary ammonium or phosphonium salt) a premature crosslinking of said elastomeric compositions (scorching phenomena) may occur.

The Applicant has faced the problem of providing elastomeric compositions having improved mechanical properties both static (in particular, tensile modulus) and dynamic (in particular, elastic modulus). The above results should be achieved without causing undesired effects on other properties such as:
viscosity, in particular too high viscosity values have to be prevented thus making it possible to obtain elastomeric compositions with good processability and good extrudability;
hysteresis (Tan delta values), in particular too high hysteresis values have to be prevented in order to avoid both a too high rolling resistance and, in particular in the case of inner structural elements of a tire, a too high operating temperatures which may lead to a degradation of the elastomeric compositions with a consequent decrease of their mechanical properties and a possible tire failure;
tear resistance, in particular a decrease in the tear resistance has to be prevented in order to avoid detachments from the other elastomeric compositions present in the tire, in particular during the use of the same.

The Applicant has now found that it is possible to obtain crosslinkable elastomeric compositions that may be advantageously used in the production of crosslinked manufactured products, in particular in the manufacturing of tires, more in particular in the manufacturing of inner structural elements of a tire, by adding to the crosslinkable elastomeric composition at least one layered material in an amount not higher than 50 phr, at least one methylene donor compound and at least one methylene acceptor compound.

The crosslinked elastomeric compositions so obtained show improved mechanical properties (both static and dinamic), said improvement being obtained without observing undesired effects on their remaining properties (i.e. viscosity, hysteresis, tear resistance). Moreover, the combination of a layered material with a methylene donor compound and a methylene acceptor compound shows a synergistic effect, in particular, on both the elastic modulus values (which increase) and the Tan delta values (which decrease) of the crosslinked elastomeric compositions so obtained.

According to a first aspect, the present invention relates to a tire comprising at least one structural element including a crosslinked elastomeric material obtained by crosslinking a crosslinkable elastomeric composition comprising:
(a) 100 phr of at least one diene elastomeric polymer;
(b) from 1 phr to 50 phr, preferably from 2 phr to 40 phr, more preferably from 5 phr to 30 phr, of at least one layered material having an individual layer thickness of from 0.01 nm to 30 nm, preferably of from 0.05 nm to 15 nm;
(c) from 0.1 phr to 15 phr, preferably from 0.3 phr to 10 phr, of at least one methylene donor compound;
(d) from 0.4 phr to 20 phr, preferably from 0.8 phr to 15 phr, of at least one methylene acceptor compound.

For the purposes of the present description and of the claims which follow, the term “phr” means the parts by weight of a given component of the crosslinkable elastomeric composition per 100 parts by weight of the diene elastomeric polymer.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

According to one preferred embodiment, the tire comprises:
a carcass structure of a substantially toroidal shape, having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure;
a pair of sidewalls applied laterally on opposite sides with respect to said carcass structure;
at least one structural element selected from bead filler, sidewall insert, tread underlayer, tread base, including a crosslinked elastomeric material obtained by crosslinking a crosslinkable elastomeric composition above disclosed.

According to a further preferred embodiment, said sidewall insert extends radially from a position corresponding to the bead structure to a position corresponding to a tread lateral edge. Said sidewall insert is usually used in the case of extended mobility tires such as, for example, run flat tires.

According to a further preferred embodiment, said tread underlayer is a layer of crosslinked elastomeric material applied in a radially internal position with respect to said tread band.

According to a further preferred embodiment, said tread band is of cap and base construction and comprises a radially inner layer or tread base and a radially outer layer or tread cap. Preferably, said radially inner layer or tread base has a thickness of at least 10%, preferably of from 20% to 70%, with respect to the total thickness of the tread band.

Preferably, said structural element has a dynamic elastic modulus (E′), measured at 70° C., not lower than 5 MPa, more preferably of from 8 MPa to 80 MPa.

Preferably, said structural element has a tensile modulus at 100% elongation (100% Modulus) not lower than 3 MPa, preferably of from 4 MPa to 20 MPa.

Preferably, said structural element has a IRHD hardness, measured at 23° C. not lower than 65, more preferably of from 70 to 95.

The tensile modulus may be measured according to Standard ISO 37:1994. The dynamic elastic modulus (E′) may be measured using an Instron dynamic device in the traction-compression mode. The IRHD hardness may be measured according to Standard ISO 48:1994. Further details regarding the above measurement methods will be given in the examples which follow.

According to a further aspect, the present invention relates to a crosslinkable elastomeric composition comprising:
(a) 100 phr of at least one diene elastomeric polymer;
(b) from 1 phr to 50 phr, preferably from 2 phr to 40 phr, more preferably from 5 phr to 30 phr, of at least one layered material having an individual layer thickness of from 0.01 nm to 30 nm, preferably of from 0.05 nm to 15 nm;
(c) from 0.1 phr to 15 phr, preferably from 0.3 phr to 10 phr, of at least one methylene donor compound;
(d) from 0.4 phr to 20 phr, preferably from 0.8 phr to 15 phr, of at least one methylene acceptor compound.

According to one preferred embodiment, said crosslinkable elastomeric composition may further comprise (e) at least one carbon black reinforcing filler.

According to a further preferred embodiment, said crosslinkable elastomeric composition may further comprise (f) at least one silane coupling agent.

According to a further preferred embodiment, said crosslinkable elastomeric composition may further comprise (g) discontinuous fibres.

According to a further aspect, the present invention relates to a crosslinked manufactured article obtained by crosslinking a crosslinkable elastomeric composition above reported.

According to one preferred embodiment, the diene elastomeric polymer (a) may be selected from those commonly used in sulfur-crosslinkable elastomeric materials, that are particularly suitable for producing tires, that is to say from elastomeric polymers or copolymers with an unsaturated chain having a glass transition temperature (T_{g}) generally below 20° C., preferably in the range of from 0° C. to −110° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene or isoprene are particularly preferred.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the diene elastomeric polymer (a) may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

According to one preferred embodiment, said crosslinkable elastomeric composition comprises at least 10% by weight, preferably from 20% by weight to 100% by weight, with respect to the total weight of the at least one diene elastomeric polymer (a), of natural or synthetic cis-1,4-polyisoprene.

The above reported crosslinkable elastomeric composition may optionally comprise at least one elastomeric polymer of one or more monoolefins with an olefinic comonomer or derivatives thereof (a′). The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

A diene elastomeric polymer (a) or an elastomeric polymer (a′) functionalized by reaction with suitable terminating agents or coupling agents may also be used. In particular, the diene elastomeric polymers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European Patent EP 451,604, or U.S. Pat. Nos. 4,742,124 and 4,550,142).

A diene elastomeric polymer (a) or an elastomeric polymer (a′) including at least one functional group selected from carboxylic groups, carboxylate groups, anhydride groups, ester groups, epoxy groups, may also be used.

Preferably, said elastomeric polymers include from 0.05% by weight to 10% by weight, preferably from 0.1% by weight to 5% by weight, with respect to the total weight of the elastomeric polymer of said at least one functional group selected from carboxylic groups, carboxylate groups, anhydride groups, ester groups.

In the case of the epoxy groups, said elastomeric polymers preferably include less than 10 mol %, preferably from 0.1 mol % to 5 mol %, of epoxy groups with respect to the total number of moles of monomers present in the elastomeric polymer.

Said functional group may be introduced into the elastomeric polymers by means of processes known in the art such as, for example, during the production of the elastomeric polymers by co-polymerization with at least one corresponding functionalized monomer containing at least one ethylenic unsaturation; or by subsequent modification of the elastomeric polymers by grafting said at least one functionalized monomer in the presence of a free radical initiator (for example, an organic peroxide).

Preferably, said functional group may be introduced into the elastomeric polymers by means of a process comprising:
feeding at least one elastomeric polymer and at least one functionalized monomer containing at least one ethylenic unsaturation into at least one extruder;
mixing and softening said mixture so as to obtain an elatomeric polymer including at least one functional group; discharge the elastomeric polymer obtained in the above step from said at least one extruder.

Functionalized monomers which may be advantageously used include, for example, monocarboxylic or dicarboxylic acids containing at least one ethylenic unsaturation or derivatives thereof, in particular salts, anhydride or esters.

Examples of monocarboxylic or dicarboxylic acids containing at least one ethylenic unsaturation or derivatives thereof are: maleic acid, fumaric acid, citraconic acid, itaconic acid, acrylic acid, methacrylic acid, and salts, anhydrides or esters derived therefrom, or mixtures thereof. Maleic anhydride is particularly preferred.

With regard to the epoxy groups, the epoxy groups may be introduced during the production of the elastomeric polymers, by co-polymerization with at least one epoxy compound containing at least one ethylenic unsaturation. Examples of epoxy compounds containing at least one ethylenic unsaturation are: glycidyl acrylate, glycidyl methacrylate, itaconic acid monoglyciyl ester, maleic acid glycidyl ester, vinylglycidyl ether, allylglycidyl ether, or mixtures thereof.

Alternatively, it is possible to introduce the epoxy groups by reacting the elastomeric polymers, in solution, with at least one epoxidizing agent. This epoxidizing agent is, generally, a peroxide, a peracid or a derivative thereof, in particular a salt thereof (for example, performic acid, perpropionic acid, peracetic acid, m-chloroperbenzoic acid, metal salts of peroxybenzoic acid such as, for example, magnesium bis(2-carboxylate-monoperoxybenzoic acid)hexahydrate or, alternatively, hydrogen peroxide in the presence of a carboxylic acid or a derivative thereof, in particular anhydrides for example, acetic acid, formic acid, propionic acid, acetic anhydride), optionally mixed with an acid catalyst (for example, sulfuric acid).

Further details regarding processes for epoxidizing elastomeric polymers are disclosed, for example, in U.S. Pat. No. 4,341,672 or by Schulz et al. in “Rubber Chemistry and Technology”, Vol. 55, pages 809 et seq.

Preferably, the epoxy groups may be introduced into the elastomeric polymers by means of a process comprising:
feeding at least one elastomeric polymer and at least one epoxidizing agent into at least one extruder;
mixing and softening said mixture obtaining an epoxidized elastomeric polymer;
discharging the obtained epoxidized elastomeric polymer from said at least one extruder.

Alternatively, the epoxy groups may be introduced into the elastomeric polymers by means of a process comprising:
feeding at least one elastomeric polymer into at least one extruder;
feeding at least one hydrogen peroxide precursor to said at least one extruder;
feeding at least one carboxylic acid or a derivative thereof to said at least one extruder;
mixing and reacting, in the presence of water, said at least one elastomeric polymer with said at least one hydrogen peroxide precursor and said at least one carboxylic acid or a derivative thereof, to obtain an epoxidized elastomeric polymer;
discharging the obtained epoxidized elastomeric polymer from said at least one extruder.

Preferably, the epoxidizing agent may be selected from those above reported.

Preferably, the hydrogen peroxide precursor may be selected, for example, from inorganic persalts (for example, sodium perborate mono- and tetra-hydrate, sodium percarbonate, potassium peroxymonosulfate), metal peroxides (for examples, magnesium peroxide, calcium peroxide, zinc peroxide), hydrogen peroxide adducts (for example, urea/hydrogen peroxide adduct), or mixtures thereof.

Preferably, the carboxylic acid or a derivative thereof may be selected, for example, from acetic acid, acetic anhydride, maleic acid, maleic anhydride, succinic acid, succinic anhydride, phthalic acid, phthalic anhydride, or mixtures thereof.

According to one preferred embodiment, the layered material (b) may be selected, for example, from phyllosilicates such as: smectites, for example, montmorillonite, bentonite, nontronite, beidellite, volkonskoite, hectorite, saponite, sauconite; vermiculite; halloisite; sericite; aluminate oxides; hydrotalcite; or mixtures thereof. Montmorillonite is particularly preferred. These layered material generally contains exchangeable cations such as sodium (Na⁺), calcium (Ca²⁺), potassium (K⁺), or magnesium (Mg²⁺), present at the interlayer surfaces.

In order to render the layered material more compatible with the elastomeric polymers said layered material (b) may be treated with at least one compatibilizing agent. Said compatibilizing agent is capable of undergoing ion exchange reactions with the cations present at the interlayers surfaces of the layerd inorganic material.

According to one preferred embodiment, said compatibilizing agent may be selected, for example, from the quaternary ammonium or phosphonium salts having general formula (I): 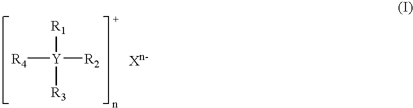
wherein:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, said cycloalkyl group possibly containing hetero atom such as oxygen, nitrogen or sulfur;
Xⁿ⁻ represents an anion such as the chlorine ion, the sulphate ion or the phosphate ion;
n represents 1, 2 or 3.

The layered material (b) may be treated with the compatibilizing agent before adding it to the elastomeric polymers. Alternatively, the layered material (b) and the compatibilizing agent may be separately added to the elastomeric polymers.

The treatment of the layered material (b) with the compatibilizing agent may be carried out according to known methods such as, for example, by an ion exchange reaction between the layered material and the compatibilizer: further details are described, for example, in U.S. Pat. Nos. 4,136,103, 5,747,560, or U.S. Pat. No. 5,952,093.

Example of layered material (b) which may be used according to the present invention and is available commercially is the product known by the name of Dellite® 67G, Dellite® 72T, Dellite® 43B, from Laviosa Chimica Mineraria S.p.A.; Cloisite® 25A, Cloisite® 10A, Cloisite® 15A, Cloisite® 20A, from Southern Clays; Nanofil® 5, Nanofil® 8, Nanofil® 9, from Süd Chemie; Bentonite® AG/3 from Dal Cin S.p.A.

According to one preferred embodiment, the methylene donor compound (c) may be selected, for example, from: hexamethylenetetramine (HMT); hexamethoxymethylmelamine (HMMM); formaldehyde; paraformaldehyde; trioxane; 2-methyl-2-nitro-1-propanal; substituted melamine resins such as N-substituted oxymethylmelamine resins; glycoluril compounds such as tetramethoxymethyl glycoluril; urea-formaldheyde resins such as butylated urea-formaldheyde resins; or mixtures thereof. Hexamethylenetetramine (HMT) or hexamethoxymethylmelamine (HMMM) are particularly preferred.

According to one preferred embodiment, the methylene acceptor compound (d) may be selected, for example, from: resorcinol; catechol; hydroquinone; pyrogallol; phloroglucinol; 1-naphthol; 2-naphthol; phenolic resins obtained from the condensation of an optionally substituted phenol with an aldehyde such as, for example, formaldehyde, acetaldehyde, furfural (for example, resorcinol-formaldehyde resin); or mixtures thereof. Resorcinol is particularly preferred.

Said methylene donor compound (c) and said methylene acceptor compound (d) may also be added to the crosslinkable elastomeric composition in the precondensed form (condensed before being added to said crosslinkable elastomeric composition) such as, resorcinol-formaldeyde resin, substituted melamine resins such as N-substituted oxymethylmelamine resins, or mixtures thereof. Said precondensed resins are able to self-crosslink as they contain different reactive groups.

As disclosed above, said crosslinkable elastomeric composition may further comprise (e) at least one carbon black reinforcing filler.

According to one preferred embodiment, the carbon black reinforcing filler may be selected from those having a surface area of not less than 20 m²/g (determined by CTAB absorption as described in Standard ISO 6810:1995).

According to one preferred embodiment, said carbon black reinforcing filler is present in the crosslinkable elastomeric composition in an amount of from 0 phr to 120 phr, preferably of from 20 phr to 90 phr.

As disclosed above, said crosslinkable elastomeric composition may further comprise (f) at least one silane coupling agent.

According to one preferred embodiment, the silane coupling agent may be selected from those having at least one hydrolizable silane group which may be identified, for example, by the following general formula (II):
(R)₃Si—CₙH₂ₙ—X (II)
wherein the groups R, which may be identical or different, are selected from: alkyl, alkoxy or aryloxy groups or from halogen atoms, on condition that at least one of the groups R is an alkoxy or aryloxy group; n is an integer of from 1 to 6 inclusive; X is a group selected from: nitroso, mercapto, amino, epoxide, vinyl, imide, chloro, —(S)ₘCₙH₂ₙ—Si—(R)₃, or —S—COR, in which m and n are integers of from 1 to 6 inclusive and the groups R are defined as above.

Among the silane coupling agents that are particularly preferred are bis(3-triethoxysilyl-propyl)tetrasulphide or bis(3-triethoxysilylpropyl)-disulphide. Said coupling agents may be used as such or as a suitable mixture with an inert filler (for example carbon black) so as to facilitate their incorporation into the elastomeric polymer.

According to one preferred embodiment, said silane coupling agent is present in the elastomeric composition in an amount of from 0 phr to 10 phr, preferably of from 0.5 phr to 5 phr.

As disclosed above, said crosslinkable elastomeric composition may further comprise (g) discontinuous fibres.

According to one preferred embodiment, the discontinuous fibres (g) are aramid fibres, in particular short fibrillated poly(para-phenyleneterephthalamide) fibres (also known as aramid pulp), of the type known commercially as Kevlar® pulp from Du Pont or Twaron® pulp from Teijin Twaron, which are disclosed in U.S. Pat. No. 4,871,004 mentioned above. Preferably, the aramid fibres used according to the present invention have a configuration with a main trunk with a length (L) of from 0.2 mm to 0.5 mm, a diameter (D) of from 0.005 mm to 0.02 mm and an aspect ratio L/D of from 10 to 1000, and a plurality of fibrils or small branches which extend outwards from said trunk over the entire length of the trunk and which have a diameter that is substantially smaller than the diameter of said trunk. The surface area of said fibres is of from 4 m²/g to 20 m²/g. The surface area of the aramid fibres according to the present invention is of from 30 to 60 times greater than that of fibres having the same diameter but not comprising fibrils.

According to a preferred embodiment, the abovementioned aramid fibres may be used either as such or in the form of a predispersion in a suitable polymer matrix which serves as a vehicle, consisting of, for example, natural rubber, butadiene/styrene copolymers, ethylene/vinyl acetate copolymers, or mixtures thereof. Preferably, a blend (“masterbatch”) in which the abovementioned fibres are dispersed in natural rubber, which is known by the trade name Kevlar® Engineered Elastomer from Du Pont and which is composed of 23% by weight of Kevlar® and 77% by weight of natural rubber, is used.

It should be pointed out that although the discontinuous fibres that are preferred according to the present invention are selected from the aramid fibres described above, said discontinuous fibres may also be selected from: fibres based on other polyamides (for example Nylon), on polyesters, on polyolefins, on polyvinyl alcohol; glass fibres; or natural fibres such as, for example, cellulose or lignine; or mixtures thereof.

According to one preferred embodiment, the discontinuous fibres are present in the crosslinkable elastomeric composition in an amount of from 0 phr to 10 phr, preferably of from 0.5 phr to 6 phr.

At least one additional reinforcing filler may advantageously be added to the above reported crosslinkable elastomeric composition, in an amount generally of from 0 phr to 120 phr, preferably of from 20 phr to 90 phr. The reinforcing filler may be selected from those commonly used for crosslinked manufactured articles, in particular for tires, such as, for example, silica, alumina, aluminosilicates, calcium carbonate, kaolin, or mixtures thereof.

The silica which may be used in the present invention may generally be a pyrogenic silica or, preferably, a precipitated silica, with a BET surface area (measured according to ISO standard 5794/1) of from 50 m²/g to 500 m²/g, preferably of from 70 m²/g to 200 m²/g.

When a reinforcing filler comprising silica is present, the crosslinkable elastomeric composition may advantageously incorporate a further silane coupling agent capable of interacting with silica and of linking it to the elastomeric polymers during the vulcanization. Examples of silane coupling agents which may be used have been already disclosed above.

The crosslinkable elastomeric composition above reported may be vulcanized according to known techniques, in particular with sulfur-based vulcanizing systems commonly used for elastomeric polymers. To this end, in the composition, after one or more steps of thermomechanical processing, a sulfur-based vulcanizing agent is incorporated together with vulcanization accelerators. In the final processing step, the temperature is generally kept below 120° C. and preferably below 100° C., so as to avoid any unwanted pre-crosslinking phenomena.

The vulcanizing agent most advantageously used is sulfur, or molecules containing sulfur (sulfur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerators that are commonly used may be selected from: dithiocarbamates, guanidine, thiourea, thiazoles, sulphenamides, thiurams, amines, xanthates, or mixtures thereof.

Said crosslinkable elastomeric composition may comprise other commonly used additives selected on the basis of the specific application for which the composition is intended. For example, the following may be added to said crosslinkable elastomeric composition: antioxidants, anti-ageing agents, plasticizers, adhesives, anti-ozone agents, modifying resins, fibres (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to said crosslinkable elastomeric composition. The amount of plasticizer generally ranges of from 0 phr to 70 phr, preferably of from of 5 phr to 30 phr.

The above reported crosslinkable elastomeric composition may be prepared by mixing together the elastomeric base components and the layered material or a masterbatch thereof, with the reinforcing filler and the other additives optionally present, according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss), or of co-rotating or counter-rotating twin-screw type.

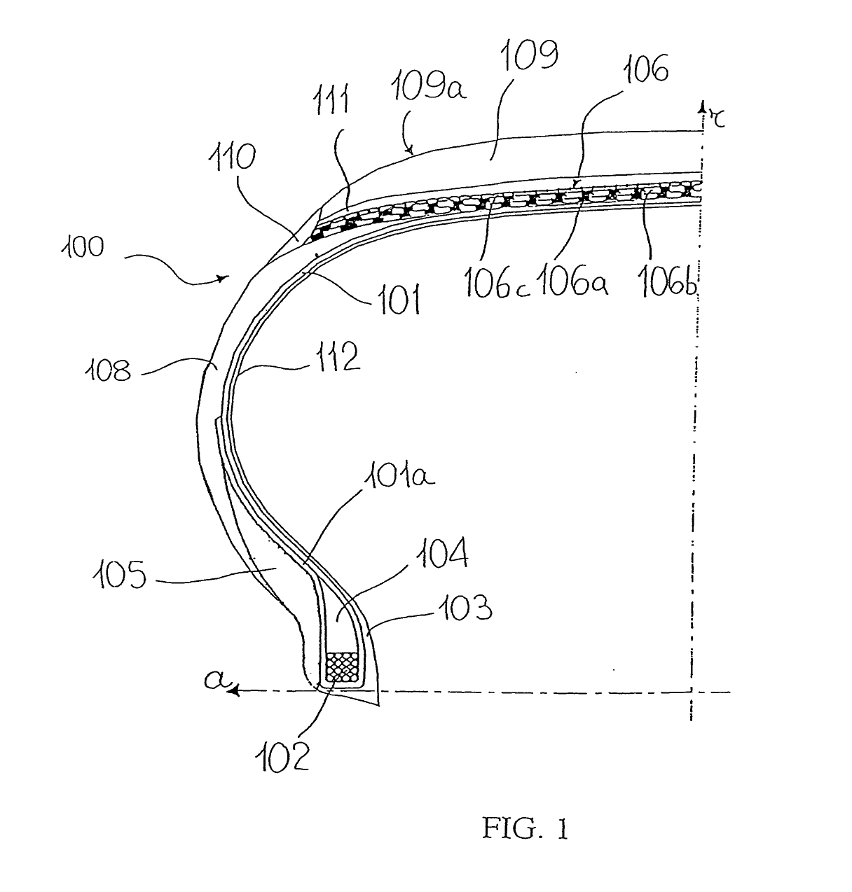

The present invention will now be illustrated in further detail by means of a number of illustrative embodiments, with reference to the attached FIG. 1-4 which are a view in cross section of a portion of a tire made according to the invention.

“a” indicates an axial direction and “r” indicates a radial direction. For simplicity, FIG. 1 shows only a portion of the tire, the remaining portion not represented being identical and symmetrically arranged with respect to the radial direction “r”.

The tire (100) comprises at least one carcass ply (101), the opposite lateral edges of which are associated with respective bead structures comprising at least one bead core (102) and at least one bead filler (104). The association between the carcass ply (101) and the bead core (102) is achieved here by folding back the opposite lateral edges of the carcass ply (101) around the bead core (102) so as to form the so-called carcass back-fold (101a) as shown in FIG. 1.

Alternatively, the conventional bead core (102) may be replaced with at least one annular insert formed from rubberized wires arranged in concentric coils (not represented in FIG. 1) (see, for example, European Patent Applications EP 928,680 and EP 928,702). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of a crosslinked elastomeric composition. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. The core (102) is enclosed in a bead (103), defined along an inner circumferential edge of the tire (100), with which the tire engages on a rim (not represented in FIG. 1) forming part of a vehicle wheel. The space defined by each carcass back-fold (101a) contains a bead filler (104) which may be made according to the present invention, wherein the bead core (102) is embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of a crosslinked elastomeric composition.

A side wall (108) is also applied externally onto the carcass ply (101), this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109) has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A tread underlayer (111) which may be made according to the present invention, is placed between the belt structure (106) and the tread band (109).

As represented in FIG. 1, the tread underlayer (111) may have uniform thickness.

Alternatively, the tread underlayer (111) may have a variable thickness in the transversal direction. For example, the thickness may be greater near its outer edges than at a central zone.

In FIG. 1, said tread underlayer (111) extends over a surface substantially corresponding to the surface of development of said belt structure (106). Alternatively, said tread underlayer (111) extends only along at least one portion of the development of said belt structure (106), for instance at opposite side portions of said belt structure (106) (not represented in FIG. 1).

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109).

In the case of tubeless tires, a rubber layer (112) generally known as a liner, which provides the necessary impermeability to the inflation air of the tire, may also be provided in an inner position relative to the carcass ply (101).

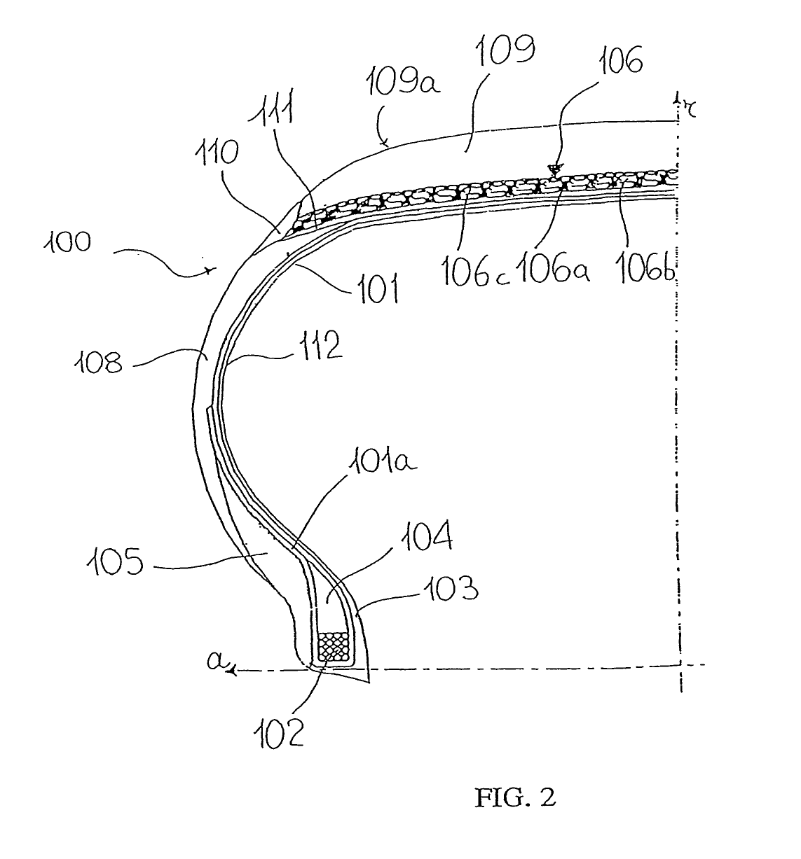

FIG. 2, shows a tire (100) having a structure as described in FIG. 1 where the tread underlayer (111) which may be made according to the present invention, is placed between the belt structure (106) and the carcass ply (101).

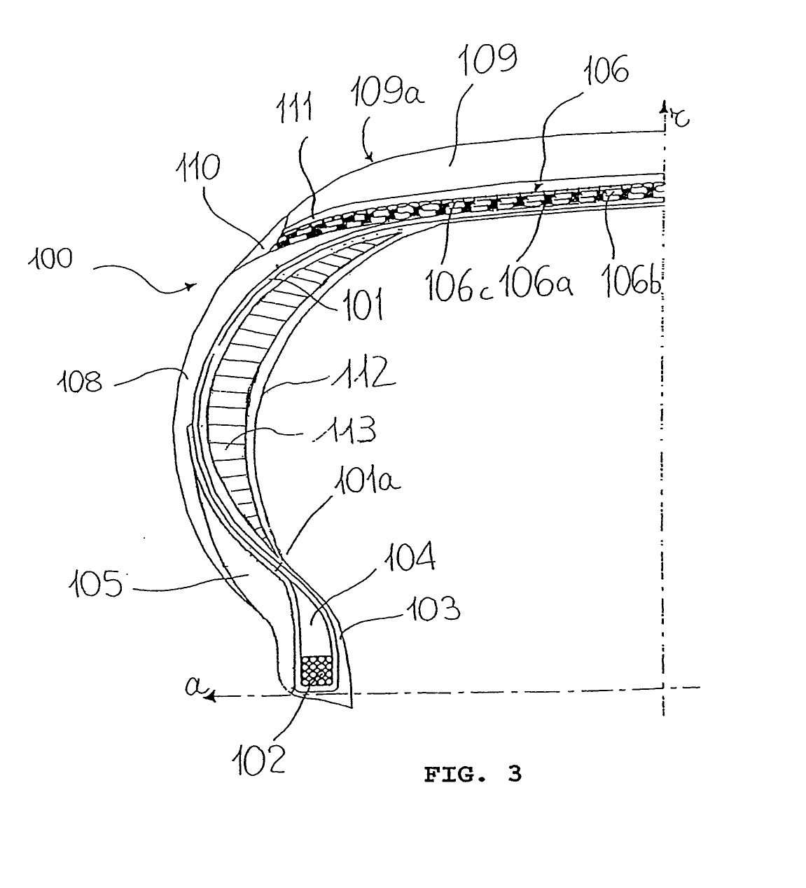

FIG. 3, shows a tire (100) having a structure as described in FIG. 1 where a sidewall insert (113) which may be made according to the present invention, which extends radially from a position corresponding to the bead structure to a position corresponding to a tread lateral edge, is placed in an axially internal position with respect to the carcass ply: for example, as represented in FIG. 3, said sidewall insert is placed between the carcass ply (101) and the liner (112). Alternatively, in the case in which more carcass plies are present, a sidewall insert (113) is placed between two of said carcass plies (not represented in FIG. 3.) Alternatively, a sidewall insert is placed between the carcass ply and the side wall (not represent in FIG. 3). More than one sidewall insert may be present as disclosed, for example, in U.S. Pat. No. 5,238,040 or in European Patent EP 943,466.

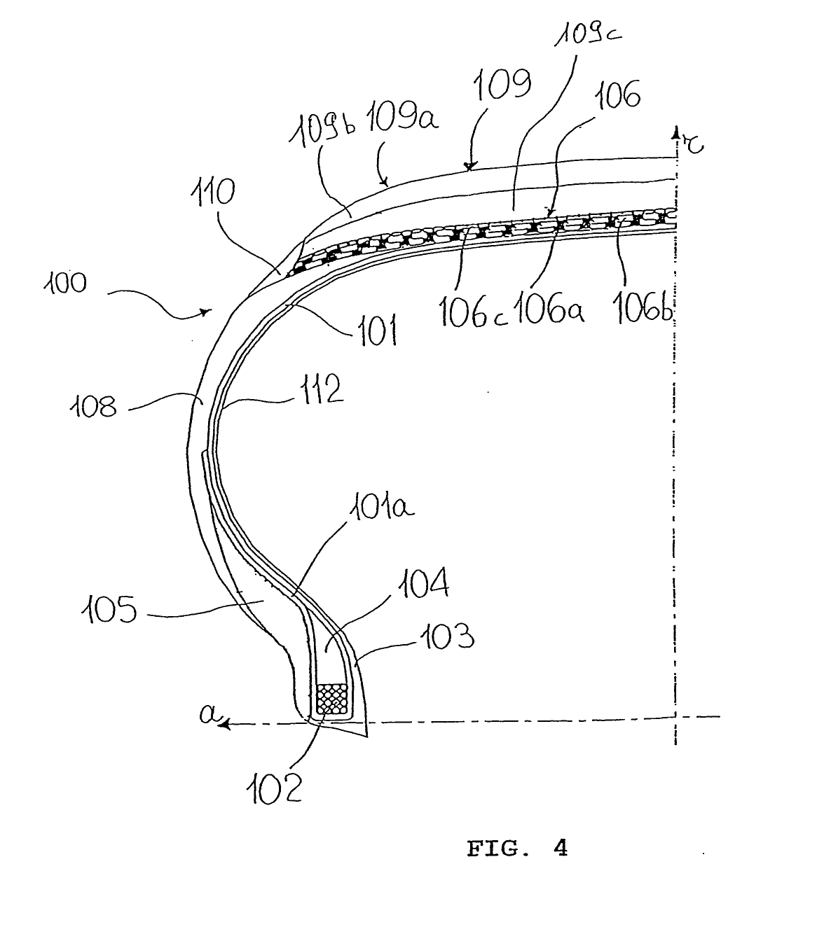

FIG. 4, shows a tire (100) having a structure as described in FIG. 1 where a tread band (109) is of cap and base construction. More in particular, said tread band (109) comprises a radially inner layer or tread base (109c) and a radially outer layer or tread cap (109b): the tread base (109c) may be made according to the present invention.

As represented in FIG. 4, the tread base (109c) has a uniform thickness. In any case, the thickness of the tread base (109c) may also be not uniform but, for example, greater near its outer edges and/or at the central zone thereof.

The process for producing the tire according to the present invention may be carried out according to techniques and using apparatus that are known in the art, as described, for example, in European Patents EP 199,064, and in U.S. Pat. No. 4,872,822 or U.S. Pat. No. 4,768,937, said process including at least one stage of manufacturing the crude tire and at least one stage of vulcanizing this tire.

More particularly, the process for producing the tire comprises the steps of preparing, beforehand and separately from each other, a series of semi-finished products corresponding to the various structural elements of the tire (carcass plies, belt structure, bead wires, fillers, sidewalls and tread band) which are then combined together using a suitable manufacturing machine. Next, the subsequent vulcanization step welds the abovementioned semi-finished products together to give a monolithic block, i.e. the finished tire.

The step of preparing the abovementioned semi-finished products will be preceded by a step of preparing and moulding the various crosslikable elastomeric compositions, of which said semi-finished products are made, according to conventional techniques.

The crude tire thus obtained is then passed to the subsequent steps of moulding and vulcanization. To this end, a vulcanization mould is used which is designed to receive the tire being processed inside a moulding cavity having walls which are countermoulded to define the outer surface of the tire when the vulcanization is complete.

Alternative processes for producing a tire or parts of a tire without using semi-finished products are disclosed, for example, in the abovementioned European Patent Applications EP 928,680 and EP 928,702.

According to one preferred embodiment, said structural elements are formed by a plurality of coils of a continuous elongated element. Said elongated element may be produced, for example, by extruding the crosslinkable elastomeric composition above disclosed.

Preferably, said structural elements are assembled onto a support.

For the purposes of the present description and of the claims which follow, the term “support” is used to indicate the following devices:
an auxiliary drum having a cilindrical shape, said auxiliary drum preferably supporting a belt structure;
a shaping drum having a substantially toroidal configuration, said shaping drum preferably supporting at least one carcass structure with a belt structure assembled thereon;
a rigid support preferably shaped according to the inner configuration of the tire.

Further details regarding said devices and the methods of forming and/or depositing the structural elements of the tire on a support are described, for example, in International Patent Application WO 01/36185 and in European Patent EP 976,536 in the name of the Applicant, or in European Patent Applications: EP 968,814, EP 1,201,414 and EP 1,211,057.

The crude tire can be moulded by introducing a pressurized fluid into the space defined by the inner surface of the tire, so as to press the outer surface of the crude tire against the walls of the moulding cavity. In one of the moulding methods widely practised, a vulcanization chamber made of elastomeric material, filled with steam and/or another fluid under pressure, is inflated inside the tire closed inside the moulding cavity. In this way, the crude tire is pushed against the inner walls of the moulding cavity, thus obtaining the desired moulding. Alternatively, the moulding may be carried out without an inflatable vulcanization chamber, by providing inside the tire a toroidal metal support shaped according to the configuration of the inner surface of the tire to be obtained as described, for example, in European Patent EP 1,189,744.

At this point, the step of vulcanizing the crude tire is carried out. To this end, the outer wall of the vulcanization mould is placed in contact with a heating fluid (generally steam) such that the outer wall reaches a maximum temperature generally of from 100° C. to 230° C. Simultaneously, the inner surface of the tire is heated to the vulcanization temperature using the same pressurized fluid used to press the tire against the walls of the moulding cavity, heated to a maximum temperature of from 100° C. to 250° C. The time required to obtain a satisfactory degree of vulcanization throughout the mass of the elastomeric material may vary in general of from 3 min to 90 min and depends mainly on the dimensions of the tire. When the vulcanization is complete, the tire is removed from the vulcanization mould.

The present invention will be further illustrated below by means of a number of preparation examples, which are given for purely indicative purposes and without any limitation of this invention.

### EXAMPLES 1-5

### Preparation of the Elastomeric Compositions

The elastomeric compositions given in Table 1 were prepared as follows (the amounts of the various components are given in phr).

All the components, except sulfur, retardant (PVI), accelerator (DCBS) and hexamethylenetetramine (HMT), were mixed together in an internal mixer (model Pomini PL 1.6) for about 5 min (1^{st} Step). As soon as the temperature reached 145±5° C., the elastomeric material was discharged. The sulfur, retardant (PVI), accelerator (DCBS) and hexamethylenetetramine (HMT), were then added and mixing was carried out in an open roll mixer (2^{nd} Step).

TABLE 1

| EXAMPLE | | | | |
|---|---|---|---|---|
| 1 (*) | 2 (*) | 3 (*) | 4 | 5 |

1^{st} STEP

| | | | | | |
|---|---|---|---|---|---|
| NR | 100 | 100 | 100 | 100 | 93.3 |
| N326 | 70 | 60 | 70 | 60 | 60 |
| Zinc oxide | 7 | 7 | 7 | 7 | 7 |
| Stearic acid | 2 | 2 | 2 | 2 | 2 |
| Antioxidant | 2 | 2 | 2 | 2 | 2 |
| X50S ® | 1 | 1 | 1 | 1 | 1 |
| Kevlar ® | — | — | — | — | 8.7 |
| Dellite ® 67G | — | 10 | — | 10 | 10 |
| Resorcinol | — | — | 1.3 | 1.3 | 1.3 |

2^{nd} STEP

| | | | | | |
|---|---|---|---|---|---|
| Sulfur | 3 | 3 | 3 | 3 | 3 |
| PVI | 0.4 | 0.4 | 0.4 | 0.4 | 0.4 |
| DCBS | 1.5 | 1.5 | 1.5 | 1.5 | 1.5 |
| HMT | — | — | 0.8 | 0.8 | 0.8 |

(*): comparative.
NR: natural rubber;
N326: carbon black;
Antioxidant: phenyl-p-phenylenediamine;
X50S ®: silane coupling agent comprising 50% by weight of carbon black and 50% by weight of bis(3-triethoxysilylpropyl) tetrasulphide (Degussa-Hüls - the reported amount relates to the silane amount);
Kevlar ® Engineered Elastomer: blend of 23% by weight of Kevlar ® and 77% by weight of natural rubber (Du Pont);
Dellite ® 67G: organo-modified montmorillonite belonging to the smectite family (Laviosa Chimica Mineraria S.p.A.);
PVI (retardant): N-cyclohexylthiophthalimide (Santogard ® PVI - Monsanto);
DCBS (accelerator): benzothiazyl-2-dicyclohexyl-sulfenamide (Vulkacit ® DZ/EGC - Bayer);
HMT: hexamethylenetetramine.

The Mooney viscosity ML(1+4) at 100° C. was measured, according to Standard ISO 289-1:1994, on the non-crosslinked elastomeric compositions obtained as described above. The results obtained are given in Table 2.

The static mechanical properties according to Standard ISO 37:1994 as well as hardness in IRHD degrees at 23° C. according to ISO standard 48:1994, were measured on samples of the abovementioned elastomeric compositions vulcanized at 170° C. for 10 min. The results obtained are given in Table 2.

Table 2 also shows the dynamic mechanical properties, measured using an Instron dynamic device in the traction-compression mode according to the following methods. A test piece of the crosslinked elastomeric composition (vulcanized at 170° C. for 10 min) having a cylindrical form (length=25 mm; diameter=12 mm), compression-preloaded up to a 10% longitudinal deformation with respect to the initial length, and kept at the prefixed temperature (23° C. or 70° C.) for the whole duration of the test, was submitted to a dynamic sinusoidal strain having an amplitude of ±3.5% with respect to the length under pre-load, with a 100 Hz frequency. The dynamic mechanical properties are expressed in terms of dynamic elastic modulus (E′) and Tan delta (loss factor) values. The Tan delta value is calculated as a ratio between viscous modulus (E″) and elastic modulus (E′).

In Table 2 the numbers in brackets indicate the % variation (% Δ_{Ref.}) of the reported values with respect to the reference values of Example 1.

TABLE 2

| | EXAMPLE | | | | |
|---|---|---|---|---|---|
| | 1 (*) | 2 (*) | 3 (*) | 4 | 5 |
| Mooney | 69 | 63 | 64 | 60 | 64 |
| viscosity ML | | | | | |
| (1 + 4) | | | | | |

STATIC MECHANICAL PROPERTIES

| | | | | | |
|---|---|---|---|---|---|
| 50% Modulus | 1.90 | 2.36 | 2.81 | 3.43 | 5.05 |
| | | (24.2%) | (47.9%) | (80.5%) | (165.8%) |
| 100% Modulus | 3.76 | 4.39 | 5.48 | 6.04 | 7.45 |
| | | (16.75%) | (45.74%) | (60.64%) | (98.13%) |
| Stress at | 17.22 | 16.37 | 17.47 | 18.70 | 16.60 |
| break (MPa) | | (−4.94%) | (1.45%) | (8.60%) | (−3.60%) |
| Elongation | 371 | 354 | 286 | 342 | 290 |
| at break | | (−4.60%) | (−22.91%) | (−7.82) | (−21.83) |

DYNAMIC MECHANICAL PROPERTIES

| | | | | | |
|---|---|---|---|---|---|
| E′ (23° C.) | 10.59 | 13.52 | 15.90 | 23.81 | 24.67 |
| | | (27.67%) | (50.14) | (124.8) | (132.9) |
| E′ (70° C.) | 9.06 | 10.44 | 11.96 | 19.11 | 20.47 |
| | | (15.23%) | (32.0%) | (110.9%) | (125.9%) |
| Tandelta | 0.247 | 0.272 | 0.253 | 0.233 | 0.228 |
| (23° C.) | | (10.12%) | (2.43%) | (−5.66%) | (−7.70%) |
| Tandelta | 0.159 | 0.192 | 0.172 | 0.166 | 0.160 |
| (70° C.) | | (20.75%) | (8.17%) | (4.40%) | (0.63%) |
| IRHD | 76 | 79 | 83 | 88 | 91 |
| Hardness | | | | | |
| (23° C.) | | | | | |
| IRHD | 72 | 73 | 78 | 83 | 88 |
| Hardness | | | | | |
| (100° C.) | | | | | |

(*): comparative.

1-71. (canceled)

72. A tire comprising at least one structural element comprising a crosslinked elastomeric material obtained by crosslinking a crosslinkable elastomeric composition comprising:
(a) 100 phr of at least one diene elastomeric polymer;
(b) 1 phr to 50 phr of at least one layered material having an individual layer thickness of 0.01 nm to 30 nm;
(c) from 0.1 phr to 15 phr of at least one methylene donor compound; and
(d) 0.4 phr to 20 phr of at least one methylene acceptor compound.

73. The tire according to claim 72, wherein said crosslinkable elastomeric composition comprises 2 phr to 40 phr of at least one layered material.

74. The tire according to claim 72, wherein said crosslinkable elastomeric composition comprises 5 phr to 30 phr of at least one layered material.

75. The tire according to claim 72, wherein said at least one layered material has an individual layer thickness of 0.05 nm to 15 nm.

76. The tire according to claim 72, wherein said crosslinkable elastomeric composition comprises 0.3 phr to 10 phr of at least one methylene donor compound.

77. The tire according to claim 72, wherein said crosslinkable elastomeric composition comprises 0.8 phr to 15 phr of at least one methylene acceptor compound.

78. The tire according to claim 72, comprising:
a carcass structure of a substantially toroidal shape, having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure;
a pair of sidewalls applied laterally on opposite sides with respect to said carcass structure; and
at least one structural element selected from bead filler, sidewall insert, tread underlayer, or tread base, obtained by crosslinking a crosslinkable elastomeric composition comprising:
(a) 100 phr of at least one diene elastomeric polymer;
(b) 1 phr to 50 phr of at least one layered material having an individual layer thickness of 0.01 nm to 30 nm;
(c) 0.1 phr to 15 phr of at least one methylene donor compound; and
(d) 0.4 phr to 20 phr at least one methylene acceptor compound.

79. The tire according to claim 78, wherein said crosslinkable elastomeric composition comprises 2 phr to 40 phr of at least one layered material.

80. The tire according to claim 78, wherein said crosslinkable elastomeric composition comprises 5 phr to 30 phr of at least one layered material.

81. The tire according to claim 78, wherein said at least one layered material has an individual layer thickness of 0.05 nm to 15 nm.

82. The tire according to claim 78, wherein said crosslinkable elastomeric composition comprises 0.3 phr to 10 phr of at least one methylene donor compound.

83. The tire according to claim 78, wherein said crosslinkable elastomeric composition comprises 0.8 phr to 15 phr of at least one methylene acceptor compound.

84. The tire according to claim 78, wherein said sidewall insert extends radially from a position corresponding to the bead structure to a position corresponding to a tread lateral edge.

85. The tire according to claim 78, wherein said tread underlayer is a layer of crosslinked elastomeric composition applied in a radially internal position with respect to said tread band.

86. The tire according to claim 78, wherein said tread band is of cap and base construction and comprises a radially inner layer or tread base and a radially outer layer or tread cap.

87. The tire according to claim 72, wherein said structural element has a dynamic elastic modulus, measured at 70° C., not lower than 5 MPa.

88. The tire according to claim 87, wherein said structural element has a dynamic elastic modulus, measured at 70° C., of 8 MPa to 80 MPa.

89. The tire according to claim 72, wherein said structural element has a tensile modulus at 100% elongation (100% Modulus) not lower than 3 MPa.

90. The tire according to claim 89, wherein said structural element has a tensile modulus at 100% elongation (100% Modulus) of 4 MPa to 20 MPa.

91. The tire according to claim 72, wherein said structural element has an IRHD hardness, measured at 23° C., not lower than 65.

92. The tire according to claim 91, wherein said structural element has an IRHD hardness, measured at 23° C., of 70 to 95.

93. The tire according to claim 72,
wherein the diene elastomeric polymer has a glass transition temperature below 20° C.

94. The tire according to claim 93, wherein the diene elastomeric polymer is selected from: natural or synthetic cis-1,4-polyisoprene, 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

95. The tire according to claim 72, wherein the crosslinkable elastomeric composition comprises at least 10% by weight with respect to the total weight of the at least one diene elastomeric polymer of natural or synthetic cis-1,4-polyisoprene.

96. The tire according to claim 95, wherein the crosslinkable elastomeric composition comprises 20% by weight to 100% by weight with respect to the total weight of the at least one diene elastomeric polymer of natural or synthetic cis-1,4-polyisoprene.

97. The tire according to claim 72, wherein the crosslinkable elastomeric composition further comprises at least one elastomeric polymer of one or more monoolefins with an olefinic comonomer or derivatives thereof.

98. The tire according to claim 97, wherein the elastomeric polymer is selected from: ethylene/propylene copolymers (EPR) or ethylene/propylene/diene copolymers (EPDM); polyisobutene; butyl rubbers; halobutyl rubbers; or mixtures thereof.

99. The tire according to claim 93, wherein the diene elastomeric polymer comprises at least one functional group selected from carboxylic groups, carboxylate groups, anhydride groups, ester groups, or epoxy groups.

100. The tire according to claim 97, wherein the at least one elastomeric polymer comprises at least one functional group selected from carboxylic groups, carboxylate groups, anhydride groups, ester groups, or epoxy groups.

101. The tire according to claim 72, wherein said layered material is selected from: phyllosilicates, smectites, montmorillonite, bentonite, nontronite, beidellite, volkonskoite, laponite, hectorite, saponite, sauconite, magadite, kenyasite, stevensite, vermiculite, halloisite, sericite, aluminate oxides, hydrotalcite, or mixtures thereof.

102. The tire according to claim 101, wherein said layered material is montmorillonite.

103. The tire according to claim 72, wherein said layered material is treated with a compatibilizing agent.

104. The tire according to claim 103, wherein said compatibilizing agent is selected from the quaternary ammonium or phosphonium salts having general formula (I): 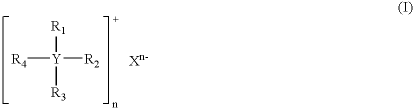
wherein:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, said cycloalkyl group possibly containing a hetero atom such as oxygen, nitrogen or sulphur;
Xⁿ−represents an anion, a chlorine ion, a sulphate ion or a phosphate ion; and
n represents 1, 2 or 3.

105. The tire according to claim 72, wherein the methylene donor compound is selected from: hexamethylenetetramine (HMT), hexamethoxymethylmelamine (HMMM), formaldehyde, paraformaldehyde, trioxane, 2-methyl-2-nitro-1-propanal, substituted melamine resins, N-substituted oxymethylmelamine resins, glycoluril compounds, tetramethoxymethyl glycoluril, urea-formaldehyde resins, butylated urea-formaldehyde resins, or mixtures thereof.

106. The tire according to claim 105, wherein the methylene donor compound is hexamethylenetetramine (HMT) or hexamethoxymethylmelamine (HMMM).

107. The tire according to claim 72, wherein the methylene acceptor compound is selected from: resorcinol, catechol, hydroquinone, pyrogallol, phloroglucinol, 1-naphthol, 2-naphthol, phenolic resins obtained from the condensation of an optionally substituted phenol with an aldehyde, formaldehyde, acetaldehyde, or furfural, or mixtures thereof.

108. The tire according to claim 107, wherein the methylene acceptor compound is resorcinol.

109. The tire according to claim 72, wherein said methylene donor compound and said methylene acceptor compound are added to the crosslinkable elastomeric composition in a precondensed form.

110. The tire according to claim 72, wherein said crosslinkable elastomeric composition comprises 0 phr to 120 phr of at least one carbon black reinforcing filler.

111. The tire according to claim 110, wherein said crosslinkable elastomeric composition comprises 20 phr to 90 phr of at least one carbon black reinforcing filler.

112. The tire according to claim 72, wherein said crosslinkable elastomeric composition comprises at least one silane coupling agent.

113. The tire according to claim 112, wherein said silane coupling agent is selected from a silane agent having at least one hydrolyzable silane group which may be identified by the following general formula (II)
(R)₃Si—CₙH₂ₙ—X (II)
wherein the groups R, which may be identical or different, are selected from: alkyl, alkoxy or aryloxy groups or from halogen atoms, on condition that at least one of the groups R is an alkoxy or aryloxy group; n is an integer of 1 to 6 inclusive; X is a group selected from: nitroso, mercapto, amino, epoxide, vinyl, imide, chloro, —(S)ₘCₙH₂ₙ—Si—(R)₃ or —S—COR in which m and n are integers of 1 to 6 inclusive and the groups R are defined as above.

114. The tire according to claim 112, wherein said silane coupling agent is present in the crosslinkable elastomeric composition in an amount of 0 phr to 10 phr.

115. The tire according to claim 114, wherein said silane coupling agent is present in the crosslinkable elastomeric composition in an amount of 0.5 phr to 5 phr.

116. The tire according to claim 72, wherein said crosslinkable elastomeric composition comprises discontinuous fibres.

117. The tire according to claim 116, wherein said discontinuous fibres are aramid fibres.

118. The tire according to claim 117, wherein said aramid fibres are short fibrillated poly(paraphenylene-terephthalamide) fibres.

119. The tire according to claim 117, wherein said aramid fibres are predispersed in a polymer matrix selected from: natural rubber, butadiene/styrene copolymers, or ethylene/vinyl acetate copolymers.

120. The tire according to claim 119, wherein said polymer matrix is natural rubber.

121. The tire according to claim 116, wherein said discontinuous fibres are selected from: fibres based on other polyamides, on polyesters, on polyolefins, on polyvinyl alcohol, glass fibres, natural fibres, cellulose, lignine, or mixtures thereof.

122. The tire according to claims 116, wherein said discontinuous fibres are present in the crosslinkable elastomeric composition in an amount of 0 phr to 10 phr.

123. The tire according to claim 122, wherein said discontinuous fibres are present in an amount of 0.5 phr to 6 phr.

124. The tire according to claim 72, wherein at least one additional reinforcing filler is present in said crosslinkable elastomeric composition in an amount of 0 phr to 120 phr.

125. The tire according to claim 124, wherein said additional reinforcing filler is silica.

126. The tire according to claim 125, wherein at least one further silane coupling agent is present.

127. A crosslinkable elastomeric composition comprising:
(a) at least one diene elastomeric polymer;
(b) 1 phr to 50 phr of at least one layered material having an individual layer thickness of 0.01 nm to 30 nm.
(c) 0.1 phr to 15 phr of at least one methylene donor compound; and
(d) 0.4 phr to 20 phr of at least one methylene acceptor compound.

128. The crosslinkable elastomeric composition according to claim 127, comprising 2 phr to 40 phr of at least one layered material.

129. The crosslinkable elastomeric composition according to claim 127, comprising 5 phr to 30 phr of at least one layered material.

130. The crosslinkable elastomeric composition according to claim 127, wherein said at least one layered material has an individual layer thickness of 0.05 nm to 15 nm.

131. The crosslinkable elastomeric composition according to claim 127, wherein said crosslinkable elastomeric composition comprises 0.3 phr to 10 phr of at least one methylene donor compound.

132. The crosslinkable elastomeric composition according to claim 127, wherein said crosslinkable elastomeric composition comprises 0.8 phr to 15 phr of at least one methylene acceptor compound.

133. The crosslinkable elastomeric composition according to claim 127, wherein said diene elastomeric polymer has a glass transition temperature below 20° C., and is selected from: natural or synthetic cis-1,4-polyisoprene, 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

134. The crosslinkable elastomeric composition according to claim 127, further comprising at least one elastomeric polymer of one or more monoolefins with an olefinic comonomer or derivatives thereof.

135. The crosslinkable elastomeric composition according to claim 134, wherein the diene elastomeric polymer or the elastomeric polymer comprise at least one functional group selected from carboxylic groups, carboxylate groups, anhydride groups, ester groups, or epoxy groups

136. The crosslinkable elastomeric composition according to claim 127, wherein the layered material is selected from: phyllosilicates, smectites, montmorillonite, bentonite, nontronite, beidellite, volkonskoite, laponite, hectorite, saponite, sauconite, magadite, kenyasite, stevensite, vermiculite, halloisite, sericite, aluminate oxides, hydrotalcite, or mixtures thereof, and/or wherein said layered material is treated with a compatibilizing agent.

137. The crosslinkable elastomeric composition according to claim 127, wherein the methylene donor compound is selected from: hexamethylenetetramine (HMT), hexamethoxymethylmelamine (HMMM), formaldehyde, paraformaldehyde, trioxane, 2-methyl-2-nitro-1-propanal, substituted melamine resins, N-substituted oxymethylmelamine resins, glycoluril compounds, tetramethoxymethyl glycoluril, urea-formaldehyde resins, butylated urea-formaldehyde resins, or mixtures thereof.

138. The crosslinkable elastomeric composition according to claim 127, wherein said methylene acceptor compound is selected from: resorcinol, catechol, hydroquinone, pyrogallol, phloroglucinol, 1-naphthol, 2-naphthol, phenolic resins obtained from the condensation of an optionally substituted phenol with an aldehyde, formaldehyde, acetaldehyde, or furfural, or mixtures thereof.

139. The crosslinkable elastomeric composition according to claim 127, wherein said methylene donor compound and said methylene acceptor compound are added in a precondensed form.

140. The crosslinkable elastomeric composition according to claim 127, wherein said crosslinkable elastomeric composition comprises at least one carbon black reinforcing filler.

141. The crosslinkable elastomeric composition according to claim 127, wherein said crosslinkable elastomeric composition comprises at least one silane coupling agent.

142. The crosslinkable elastomeric composition according to claim 127, wherein at least one additional reinforcing filler is present in an amount of 0 phr to 120 phr.

143. The crosslinkable elastomeric composition according to claim 142, wherein the additional reinforcing filler is silica.

144. The crosslinkable elastomeric composition according to claim 143, wherein at least one silane coupling agent is present.

145. The crosslinkable elastomeric composition according to claim 127, further comprising discontinuous fibres.

146. A crosslinked manufactured article obtained by crosslinking a crosslinkable elastomeric composition defined according to claim 127.
